(19) United States
(12) Patent Application Publication
(10) Pub. No.: US 2013/0207587 A1
(43) Pub. Date: Aug. 15, 2013

(54) Control System For Electrically Powered Vehicles

(71) Applicants: Thomas Nesbitt, Somerset (GB); Gary Rowlands, Somerset (GB)

(72) Inventors: Thomas Nesbitt, Somerset (GB); Gary Rowlands, Somerset (GB)

(21) Appl. No.: 13/581,309

(22) PCT Filed: Feb. 24, 2011
(86) PCT No.: PCT/GB11/50366

§ 371 Date: Aug. 25, 2012

(30) Foreign Application Priority Data
Feb. 25, 2010 (GB) 1003125.0

(51) Int. Cl. B60L 15/20

(52) U.S. Cl. CPC B60L 15/20
USPC 318/543

(57) ABSTRACT

A circuit, for controlling a vehicle having an electric motor, the circuit comprising throttle means operable to generate an output signal; adjuster means operable to modify the output signal to above a predetermined minimum level, and controller means operable to receive the modified output signal and derive an input signal for provision to the electric motor.

The present invention relates to a control system for electrically powered vehicles and, in particular, to a control system to ensure that an electrically powered vehicle is only able to move when a user determines that it should.

With vehicles powered by an internal combustion engine, the sound of the combustion engine acts as a feedback mechanism alerting users that the engine is operating. Because of this, when the engine is operating, users ensure the vehicle does not continue to move of its own volition by actively disengaging the engine from the driving or gear mechanism. For example, a motorcycle with an internal combustion engine is never ready to drive without the knowledge of the rider by virtue of the fact that the rider can hear the engine. If the engine is operating and the gears are engaged, the machine could move at any time. Therefore, the rider is prompted to hold in the clutch to disengage the gearing from the engine, or make sure gearing is in a neutral position. Alternatively the rider could turn the engine off.

However, with an electrically powered vehicle, such as an electrically powered motorcycle, the motor does not emit a noise when it is operating. Therefore, there is no engine idle noise to act as a signal to the rider. The vehicle can be ready to drive and yet appear to the operator as if it is completely “dead” or switched off. Furthermore, these vehicles are not necessarily provided with a mechanical gear selector, often having no gears or clutch mechanism provided, or required, at all. This is, therefore, an extremely dangerous situation as the rider, or another person standing next to the vehicle, can twist the throttle a little and the vehicle could move forward, with potentially great acceleration. This would endanger not only the operator, but any bystanders in the path of the vehicle. The situation would be equally dangerous in vehicles having a gear selector which the operator had left engaged in a gear.

A variety of systems have been implemented which aim to ensure that an electrically powered vehicle will move only when the operator chooses to make it move.

For example, Dead Man's handles can be attached to the handlebars of a motorcycle or other vehicle. These handles are provided with a mechanism that will be compressed when the operator is holding the handlebars. Whilst the mechanism is compressed, the motor system can operate; when the mechanism is released the motor system will automatically deactivate. However, it will be easily understood that the handles could be activated when the operator is not in the preferred operating position of the vehicle, for example when attempting to lead the motorcycle by the handlebars, whilst walking, to a desired spot such as a parking space or garage. With Dead man's handles this action could result in the compression of the mechanism and thus activate the motor whilst in an example the rider was off the bike and not wanting it to move of its own volition.

Alternatively, a pressure sensor could be provided in the vehicle seat. However, this would still require the operator to remember, without an audible signal, that the motor should be disengaged if he is sitting on the vehicle after he has slowed it to a rest. Furthermore, even with this system, a bystander could twist the throttle when the operator is sat on the seat. Another drawback to the seat pressure sensor is that in the example of the motorcycle, if the rider were to stand up during riding, for example to accommodate bumpy terrain, the sensor would cause the motor to disengage which is unlikely to be the intention of the rider.

An audible alert which sounds when the vehicle motor is turned on would warn of the danger of the active machine. However, these alerts may cause annoyance and, as a result, operators may disengage the alert, which would render it useless and leave the original problem extant.

Another solution is that a visible warning system, such as a warning light or lights, can be implemented. However, if the light is too small, it may be ignored or missed; if the light is too big, it could be a distraction. If the warning light failed, for any reason such as bulb failure, and the failure went un-noticed, the operator could falsely assume the motor to be off when it was in fact active. This could result in the dangerous situation the warning lights were intended to avoid. Visuals warning, as the only warning and safety system, are insufficient due to environmental conditions and technical failures. Operator error or distraction may also result in system failure and potential accidents when visible or audible warning systems are used as the only interface between the vehicle and operator.

According to a first aspect of the present invention there is provided a circuit, for controlling a vehicle having an electric motor, the circuit comprising: a throttle unit operable to generate an output signal; an adjuster unit operable to modify the output signal to above a predetermined minimum level and a controller unit operable to receive the modified output signal and derive an input signal for provision to the electric motor.

The provision of an adjustor unit within the circuit, to ensure that the output signal is modified, for example to above a minimum level, means that the electric motor will never reach a state below a predetermined minimum level when the circuit is in operation. In the case of the input signal to the electric motor determining the speed of, or driving power supplied to, the electric motor, this means the electric motor will not reach below a predetermined minimum speed when the circuit is in operation.

Preferably the output signal generated by the throttle unit is an indicator of required output of the electric motor.

Conveniently the throttle unit is operable to generate an output signal equating to zero output from the electric motor.

Preferably the adjustor unit is operable to modify the output signal which is obtained when the throttle is in that position which normally produces zero output from the motor, indicating zero output such that a minimum output above zero is obtained from the motor.

The circuit may further comprise a switching system operable to selectively disconnect the controller unit from the electric motor.

Conveniently, the switching system comprises a switching unit wherein the switching unit may comprise at least one brake switch.

It will be understood that the at least one brake switch may be of the type including, but not limited to, a pressure sensitive brake switch, a mechanical switch and a hydraulic switch.

The switching system may comprise a toggle unit wherein the toggle unit may comprise a toggle switch. The toggle unit may alternatively comprise a latch.

Conveniently the toggle switch is operable to switch or latch between at least two states.

In one embodiment, the throttle unit includes a variable resistor. Alternatively, the throttle unit may include a potential divider circuit.

In a further embodiment, the throttle unit includes a potentiometer.

The adjuster unit may comprise a resistor.

According to a second aspect of the present invention there is provided a circuit, for controlling a vehicle having an electric motor, the circuit comprising: a throttle unit operable to generate an output signal; an adjuster unit operable to modify the output signal to above a predetermined minimum level; a controller unit operable to receive the modified output signal and derive an input signal for provision to the electric motor and a toggle unit operable to latch the circuit between at least two states wherein each state corresponds to a mode of operation of the electric motor.

The provision of an adjustor unit within the circuit, to ensure that the output signal is modified, for example to above a minimum level, means that the electric motor will never reach a state below a predetermined minimum level when the circuit is in operation. The provision of a toggle unit within the circuit enable the operational state of the motor to be selected, for example to switch the electric motor off, to make it active or to have it in a neutral state.

The toggle unit may a toggle switch. Alternatively, toggle unit may be a latching circuit and may further comprise a latching control unit.

It will be understood that the term vehicle is intended to include electrically powered bicycles, mopeds, motorcycles, tricycles or quad bikes as well as other electrically powered vehicles such as cleaning machines, golf carts and disabled vehicles. Typically these electrically powered vehicles are of the type operable by handlebars or joysticks. Hybrid vehicles and partially electric vehicles are also included in this definition.

These and other aspects of the invention will become apparent from the following descriptions when taken in combination with the accompanying drawings in which:

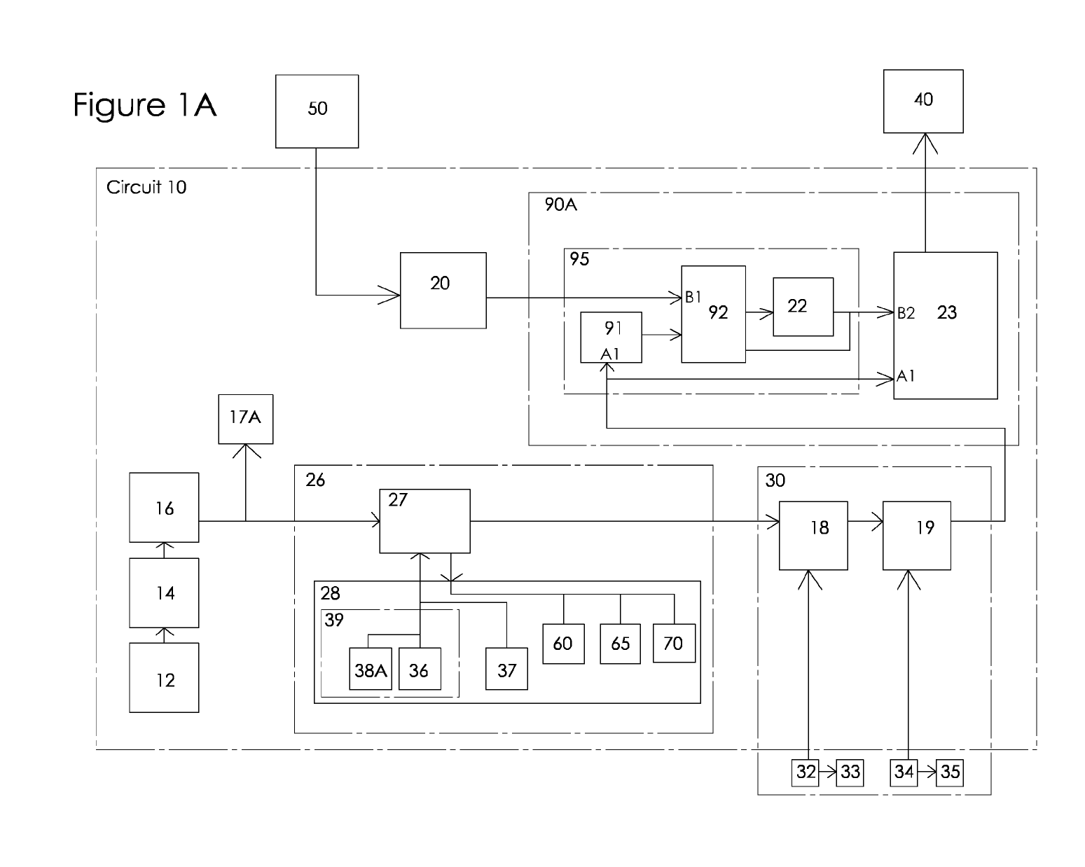

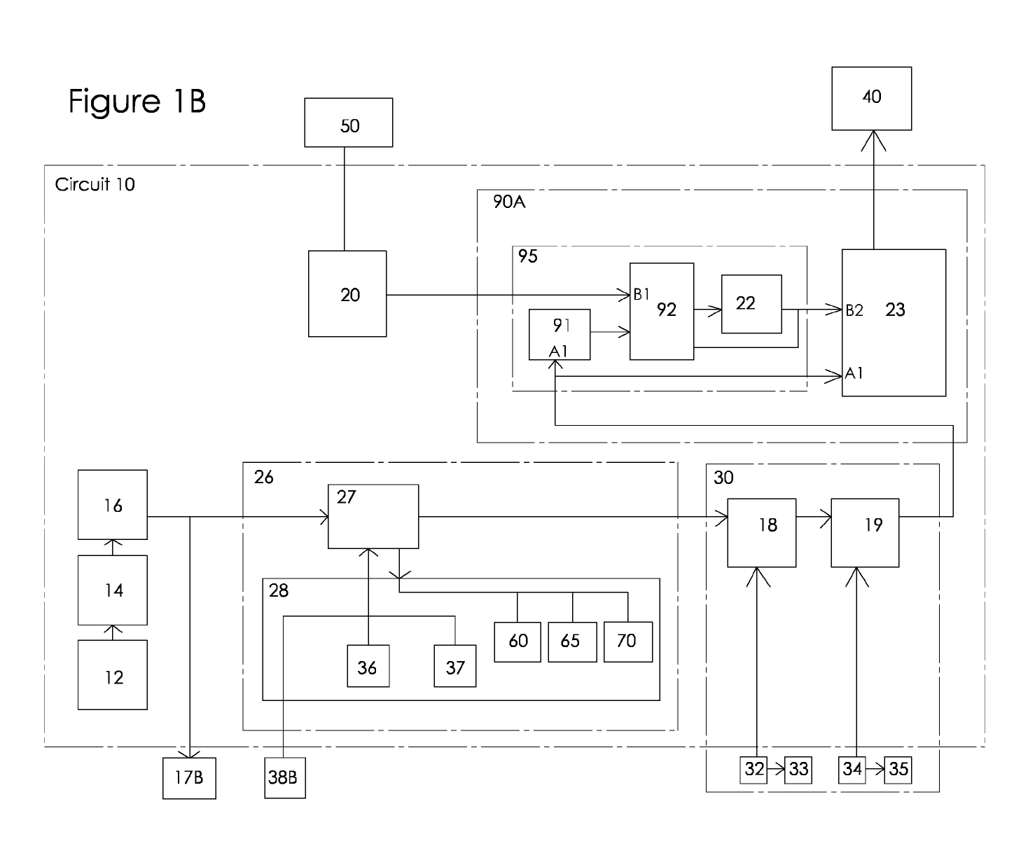

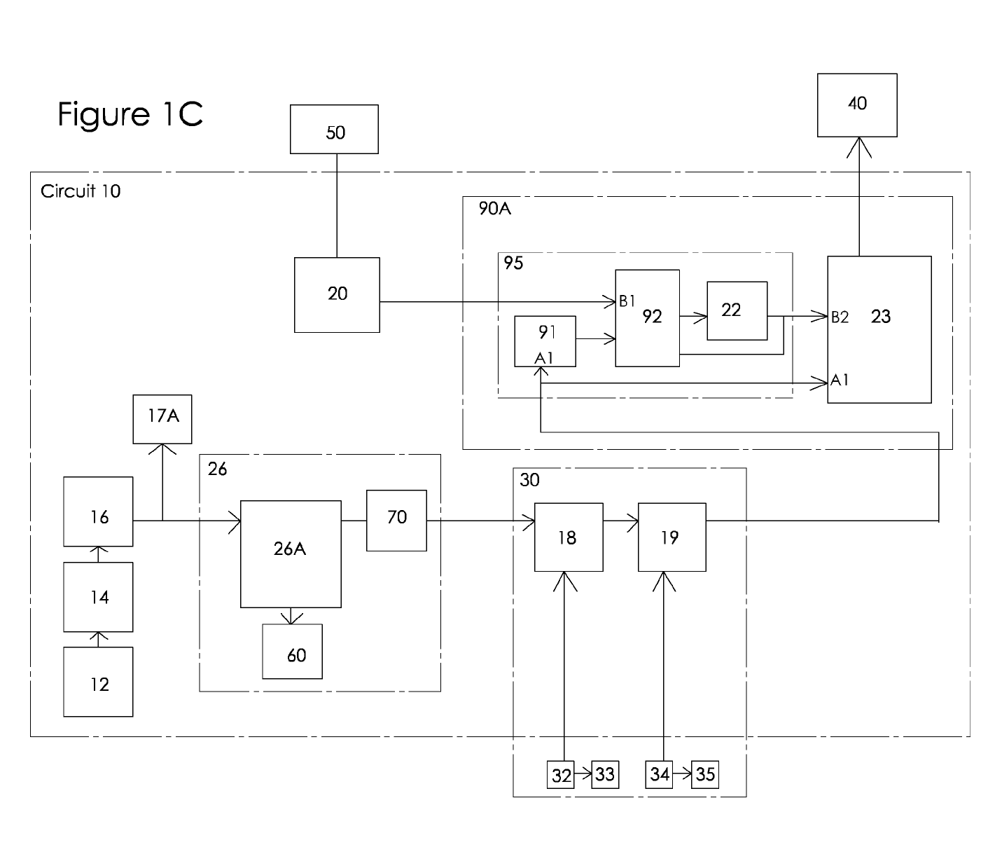

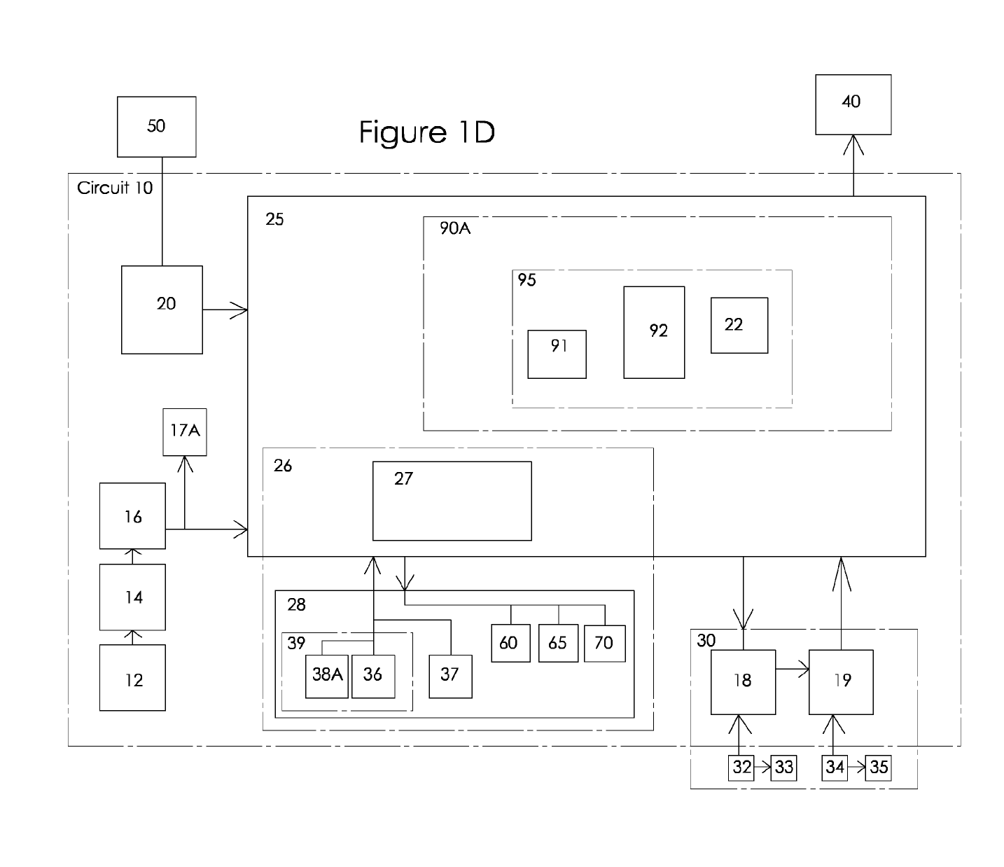

FIG. 1A is a schematic representation of an electrical powered vehicle circuit, within the context of the relevant vehicle components, including a first embodiment of a control system circuit according to an example;

FIG. 1B is a schematic representation of an electrical powered vehicle circuit, within the context of the relevant vehicle components, including a second embodiment of a control system circuit according to an example;

FIG. 1C is a schematic representation of an electrical powered vehicle circuit, within the context of the relevant vehicle components, including a third embodiment of a control system circuit according to an example;

FIG. 1D is a schematic representation of an electrical powered vehicle circuit, within the context of the relevant vehicle components, including a fourth embodiment of a control system circuit according to an example;

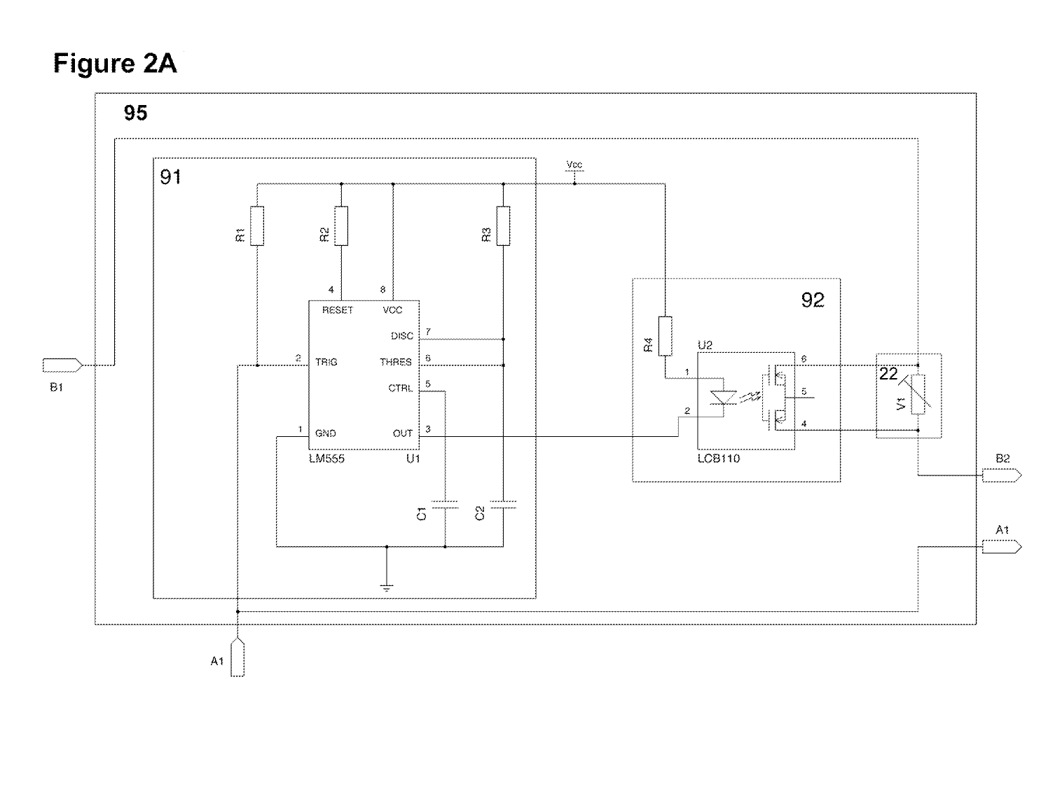

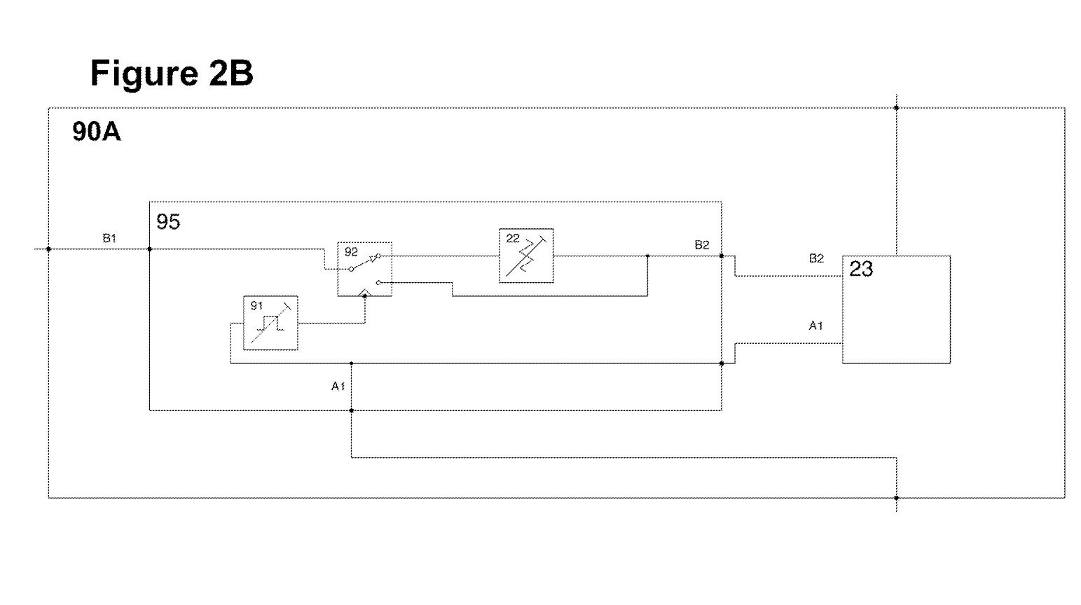

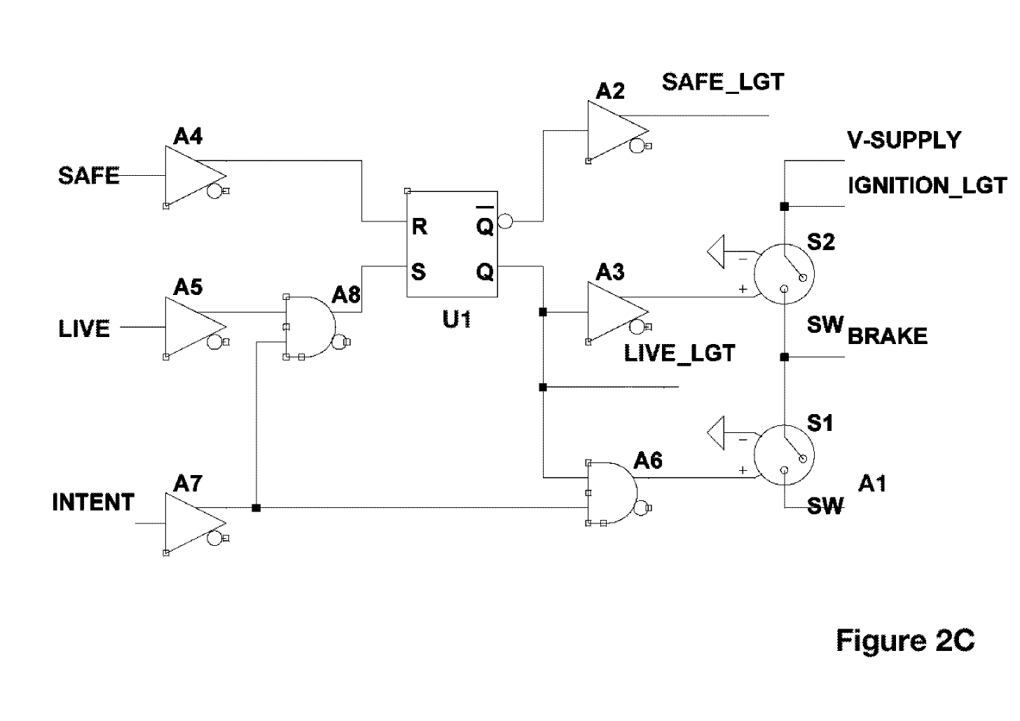

FIG. 2A is a schematic electronics diagram of an aspect of the control system circuit of FIGS. 1A, B, C or D according to an example;

FIG. 2B is a schematic circuit diagram showing an alternative embodiment of an aspect of the control system circuit of FIG. 1A, B, C or D according to an example;

FIG. 2C is a schematic circuit diagram showing an aspect of the control system circuit of FIG. 1A, B, C or D according to an example;

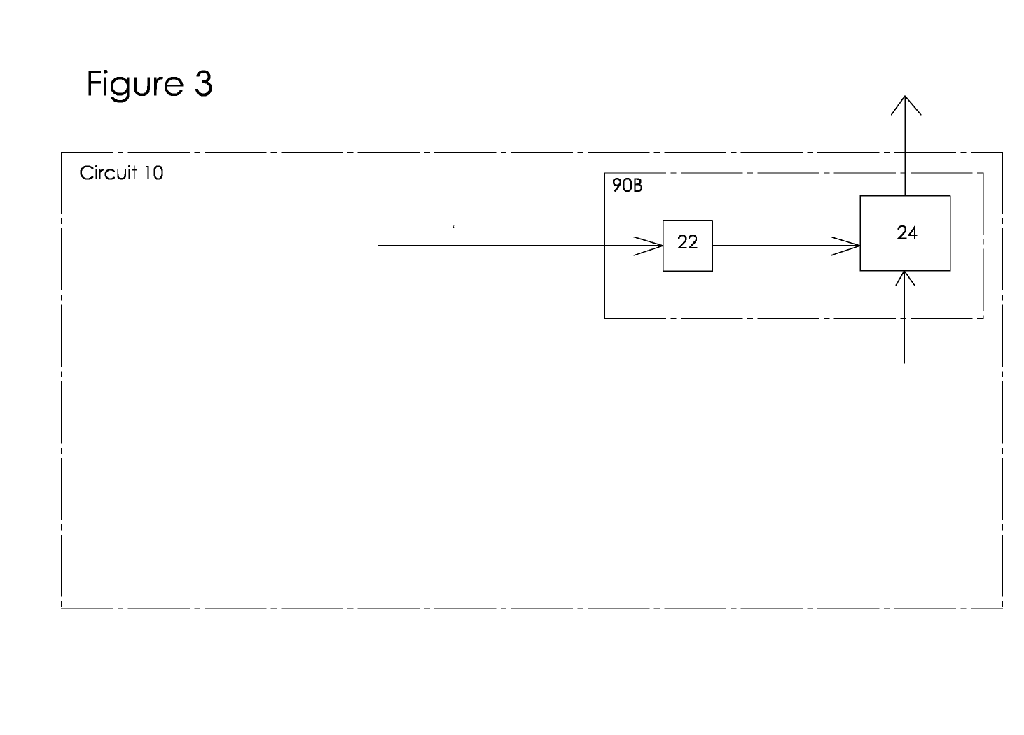

FIG. 3 is a schematic representation of an aspect of a fifth embodiment of a control system circuit according to an example;

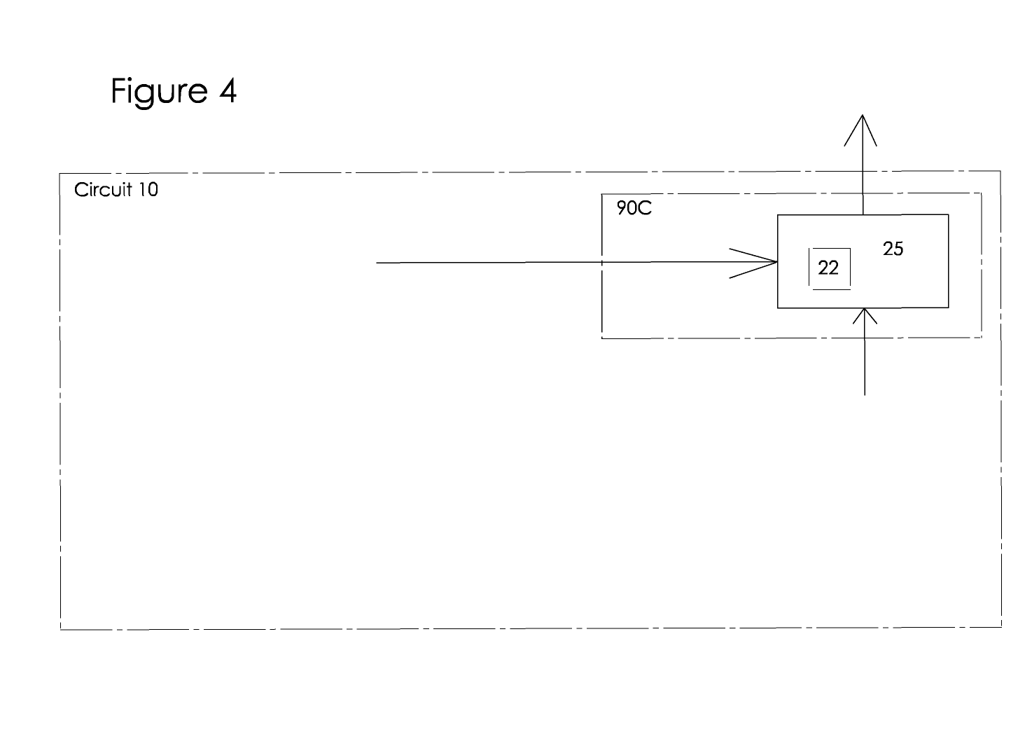

FIG. 4 is a schematic representation of an aspect of a sixth embodiment of a control system circuit according to an example;

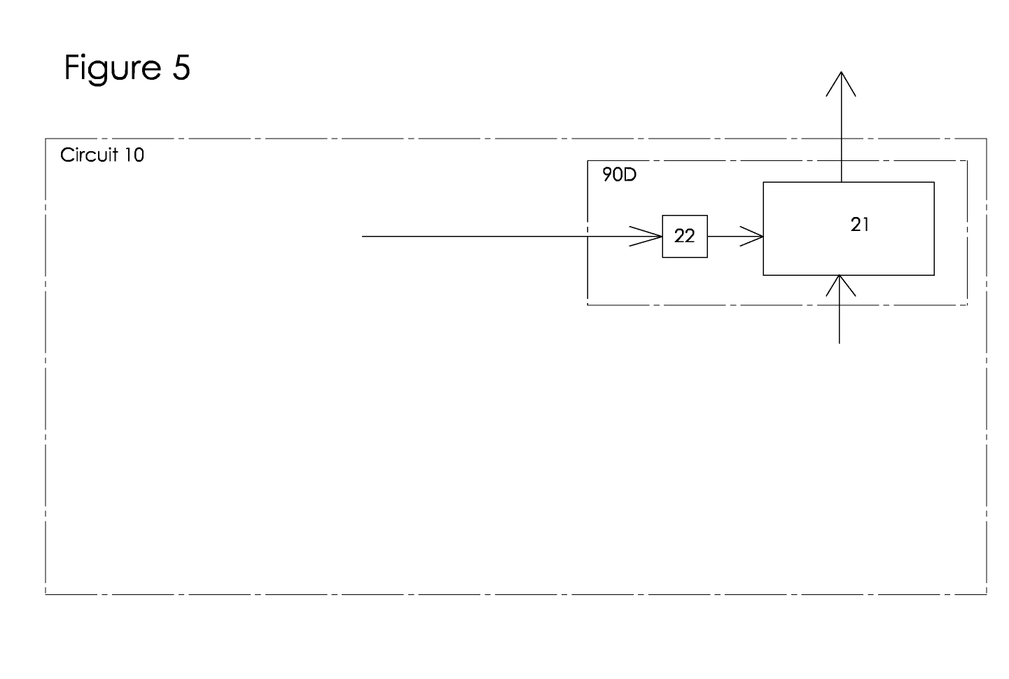

FIG. 5 is a schematic representation of an aspect of a seventh embodiment of a control system circuit according to an example; and

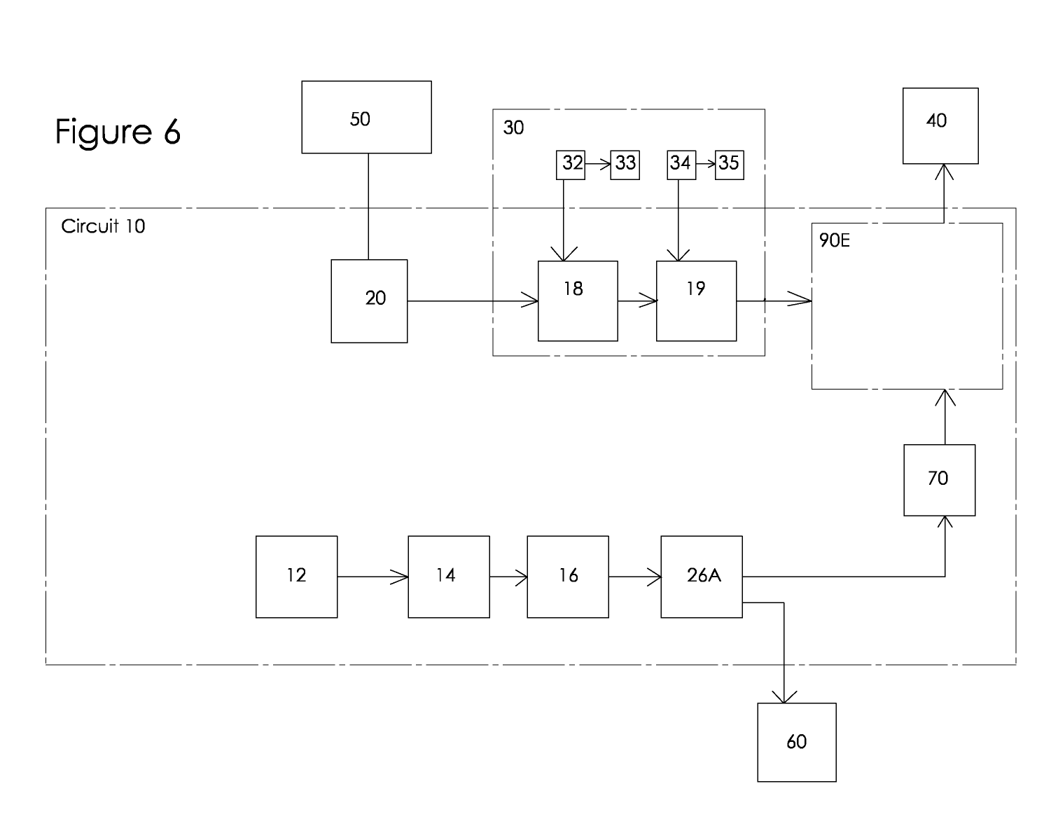

FIG. 6 is a schematic representation of an alternative embodiment of an electrical powered vehicle circuit, within the context of the relevant vehicle components, according to an example.

With reference to FIG. 1A, the circuit 10 comprises a power supply 12 which is derived from the power supply to the vehicle, typically a battery (not shown), ignition 14, which in this case is a key switch; system status device 16; an indicator 17A, a toggle unit 26, which in this case comprises a latching circuit 27 and a latching control unit 28 which includes Safe button 38A, Intent button 36, Live button 37 and indicator units 60 65 and 70; a switching unit 30, in this case comprising brake switches 18 and 19, which are closed in the default position; operation unit 90A comprising a controller unit, in this case motor controller 23 and an adjuster unit 95 in this case a signal adjusting unit comprising timer device 91, switching device 92 and resistor 22; and a throttle unit, in this case throttle circuit 20, all of which are connected in series. The circuit 10 includes a throttle actuator mechanism 50 in connection with throttle circuit 20

System status device 16 performs several functions including monitoring the charge of the batteries and ensuring there is sufficient power to activate the vehicle systems. In this case the system status device 16 provides a positive signal when the power supply 12 is of sufficient status and the ignition 14 is turned on and a positive signal which enables a Drive or Live mode signal to be provided to motor controller 23 in dependence upon the status of the remainder of the circuit 10.

Toggle unit 26 can latch the circuit 10 between two main states, one which places the circuit 10 in a Neutral or Safe mode and another which places the circuit 10 in a Drive or Live mode. For the purposes of the description, “Safe” will be the term used to describe the vehicle being in a Neutral mode and “Live” will be used to describe the vehicle being in a Drive mode. By setting the toggle unit 26 to Safe the indicator light 60, which in this case is a red light, is illuminated. The indicator light 60 is not illuminated when the toggle unit 26 is set to Live and instead a signal is sent by latching circuit 27 to activate Live indicator device 70, which in this case is a green light, and thus subsequently to motor controller 23. When the Intent button is pressed for the start-up procedure or other operational modes an amber light 65 is illuminated for the duration that the button is pressed but only for this time. Failure of the indicator light bulbs, diodes, or other devices will not adversely affect the function of circuit 10 and use of a multi element light bulb can provide greater certainly in an example of the indicator light 60 illuminating when the toggle unit 26 is placed in Safe mode.

In this embodiment, indicator light 60 65 and 70 are LED's, however it will be appreciated that any suitable indicator source could be used.

Brake switch 18 is connected to the rear brake lever 32 which is in turn connected to the rear mechanical brakes 33. Brake switch 19 is connected to the front brake lever 34 which is in turn connected to the front mechanical brakes 35. In this case, the brake levers 32 and 34 create a hydraulic pressure and actuate pressure sensitive brake switches 18 and 19 whilst also causing the mechanical brakes 33 and 35 to be applied to the vehicle. It will be appreciated that the vehicle could alternatively be provided with a unified braking system which would act upon the circuit and actuate the mechanical brakes 33 and 35. It will also be appreciated that the brake levers 32, 34 are not restricted only to lever mechanisms and instead any suitable brake control arrangement could be used.

The throttle circuit 20 generates a signal which will be provided to the electric motor 40 by way of the motor controller 23 when the toggle unit 26 is in Live mode. The signal generated will control the speed output from the electric motor 40 which will be variable from a very low speed, or minor movement, to top speed. The throttle circuit 20 is controlled by throttle actuator mechanism 50 which is an interface device for the operator of the vehicle to control the speed via the throttle circuit 20. In this case, the throttle actuator mechanism is a twistable throttle handle 50 provided as one of the handles of the motorcycle. The throttle circuit 20 is, in this case, provided with a potentiometer (not shown) which in this case acts as variable resistor. The potentiometer acts to supply a variable resistance signal to the controller 23, this signal changes the output from the motor controller 23 to the electric motor 40. In this embodiment, 0-5 kΩ is the resistive range provided by the potentiometer with 0 kΩ being equivalent to an output signal from the throttle circuit 20 indicating zero speed and 5 kΩ being full speed. It will be appreciated that the signal provided by actuation of the throttle handle 50 may alternatively be a more complex signal. The throttle type is determined by the motor controller 23. The controller 23 effectively scans for the variable resistance but is actually receiving a fluctuating voltage signal by virtue of the internal components.

It will be appreciated that the potentiometer could similarly act to provide a variable voltage and maybe a more complex signal to the controller 23.

Within operation unit 90A, timer device 91 is a monostable circuit that fires a short pulse to change-over switching device 92 upon receiving a signal indicating the circuit 10 is in Live mode. The change-over switching element, 92, momentarily by-passes the throttle modification element, 22 then returns (fail-safe) to having element 22 in-line with the throttle control. Timer device 91 is implemented with an integrated timer chip such as the industry standard 555 chip, but it is understood that any timing element that is capable of switching a short pulse could be used. Switching element 92 is implemented as two solid-state switching devices, one normally open and one normally closed. Alternatively, it will be understood that the switching element 92 could be a mechanical relay or any electrical device capable of providing a bypass to resistor 22.

In the case when the electric motor 40 is in, what in a normal motor would be, an “idling” mode, it instead results in a creep; a mode of slow motion. The Creep effect occurs whilst the throttle circuit 20 is generating an output signal which would ordinarily result in zero speed.

Adjuster unit 95 is provided between the throttle circuit 20 and the motor controller 23 and the resistance of resistor 22 is of an appropriate specification such as to prevent an output signal equivalent to zero speed being input to the motor controller 23. Instead, the modified signal input into the motor controller 23 is equivalent to a slow speed or minor movement resulting in Creep occurring. It will be appreciated that whilst the adjuster unit 95 is described in this embodiment as a discreet unit from motor controller 23, it will be apparent from further embodiments that the motor controller 23 may be provided with the functionality to undertake the role of the adjuster unit 95 within circuit 10.

When the ignition 14 is turned on, the circuit 10 is arranged to default into Safe mode. The ignition 14 can be turned off whilst the circuit 10 is in Live mode or Safe mode according to an example.

The latching circuit 27 and latching circuit controls 28 work in combination within toggle unit 26. In this case, the latching circuit controls 28 are handlebar mounted push button switches, operable by way of a momentary push, but it will be appreciated they could be any suitable electrical or mechanical switch or combination of switches or actuators.

Within latching controls 28, in this example describing a motorcycle layout, there is provided an Intent button 36 which, in use, is preferably fitted to the left side of the handlebars and a Live button 37 which in use is preferably fitted on the right side of the handlebars. The preferred scheme and in this case the Intent button 36 is amber in colour and Live button 37 is green in colour, however it will be appreciated that other colours may be used. A further button, the Safe button 38A, is provided in latching controls 28 which in this case is red in colour, however as with the other LED's it will be appreciated that another colour may be used. In use, the Safe button 38A is preferably positioned on the left of the handlebars as this is typically the opposite side of the handlebars to the throttle handle 50 and so an operator wishing to make the vehicle safe while the throttle handle 50 is being activated could do so. It will be appreciated that whilst the Intent button 36 and Safe button 38A have been detailed as separate buttons, they may be combined into one centrally sprung rocker unit 39 and in use, the rocker unit would be preferably arranged such that the Intent portion of the unit is located closer to the ground than the Safe portion of the button designed so that it can be easily pressed in an emergency but not unintentionally.

The Intent button 36, is operable as part of a sequence to set the circuit 10 to Creep mode, however, it also has a brake interlock override function as pressing the Intent button 36 whilst applying any of brakes 32-35 will allow creep to continue and allow the throttle 50 to function for the period during which Intent button 36 is pressed. The override function is available to the operator only once Live mode has been enabled as, at any point within Live mode, the Intent button 36 can be pressed and for the duration that the button 36 is being pressed the brake interlock function is disabled allowing the throttle circuit 20 to continue controlling the motor in the normal way. Creep is still present at zero throttle while the Intent button 36 is being depressed to implement the brake interlock override function.

The switches 36, 37 and 38A facilitate a momentary closed circuit when pressed which activates the latching circuit 27 to implement the desired control mode. Therefore, when the ignition 14 is switched on, the circuit 10 is activated so that the vehicle is ready for use, but no power can be applied by the throttle circuit 20 through actuation of throttle handle 50 and no Creep will occur as the circuit 10 is in Safe mode. To indicate that circuit 10 is in “Active” mode indicator light 17A or 17B is illuminated. The normal start-up procedure in this instance is when toggle unit 26 is initiated to place the circuit 10 in Live mode, then Creep is immediately commenced. The user can stop the Creep at any time by the application of rear brake lever 32, front brake lever 34 or by pushing the Safe button 38A to activate Safe mode. Live mode would be resumed upon release of the brake 32, 34 as these interruptions to Creep mode are temporary. However, if Creep has been stopped by pressing the Safe button 38A or 38B, this disables the Creep more permanently with Creep then being reengaged through the normal start-up procedure of firstly holding the Intent button 36 and simultaneously pressing Live button 37. Alternatively, the circuit 10 could be deactivated and the vehicle operation stopped completely, by the turning off ignition 14. To use the vehicle again, the user will recommence the process by actuating the ignition 14 and moving through the normal start-up procedure.

The resistor 22 is chosen such that the minimum allowed input signal to the motor controller is equivalent to a slow speed of, for example, 1 mile per hour, or similarly slow speed which acts as a physical indication that the vehicle is activated/powered. The operator cannot therefore ignore that the vehicle is still in motion. Whilst resistor 22 is in this embodiment a variable resistor set such that the creep speed of the motor is sufficient to be obvious to the user, it will understood that any electrical element or circuit, or software implemented in a circuit, that can provide a signal to the motor controller can be used. The signal provided can be that to cause a forward motion or a judder of the vehicle for example.

Motor controller 23 is provided with a “high pedal lockout” (HPLO) circuit (not shown) which is typically found in many motor controller systems and overcomes the situation where the ignition 14 can be turned on while the throttle circuit 20 is not outputting a signal representing zero speed. This is also known as “high pedal detect” HPD and may be known by other terms. A HPLO type circuit is reset and becomes re-enabled once the throttle input has returned to a zero speed signal or a no motion signal. The HPLO circuit does this by sensing the resistance of the potentiometer within the throttle circuit 20. If the potentiometer is not at a setting to provide a zero speed signal when switched on, the HPLO circuit disables the controller 23. Once the potentiometer within the throttle circuit 20 is adjusted accordingly, the HPLO circuit actions the controller 23 to reset itself automatically. The motor controller 23 in operation unit 90A is provided with HPLO which by its nature can not be over ridden. To overcome this, timer device 91 and switching device 92 provide a bypass mechanism whereby, on receiving an activation signal, momentarily bypass element 22, resetting the motor-controller 23, thus temporarily overcoming the HPLO.

Thereafter the throttle circuit 20 must be reset each time the motor controller 23 is turned off in the usual HPLO manner by disabling the controller 23 until the throttle circuit 20 is adjusted such that it would provide a reset signal as is determined by adjuster unit 95.

When the toggle unit 26 is in Live mode, and the controller 23 is providing a drive signal to motor 40, activation of either one or both brake switches 18 and/or 19 will break the circuit 10. This will cause the motor controller 23 to disengage from applying any power signal to the motor 40 and at the same time will action application of the mechanical brakes 33 and/or 35. In turn, the throttle circuit 20 will, in view of the HPLO circuit, have to be reset by the operator so that on release of the brakes 32 and/or 34 the motor controller 23 can re-connect and power be supplied to the motor 40 thus preventing any unexpected acceleration on release of the brakes.

The management of the output of speed from the motor 40 can also be actioned by toggle unit 26. Whilst the toggle unit 26 is in Safe mode, the motor 40 is effectively isolated from the power supply and the throttle circuit 20 is disabled. However, the main ignition circuit (not shown) can remain enabled to provide power for other systems on the vehicle such as lights or satellite navigation for example. When the toggle unit 26 is actuated for Live mode, activation of the throttle circuit 20 and generation of a corresponding power signal by the motor controller 23 will result in the motor 40 responding by causing an increase in speed.

In use, the modification of the output signal from the throttle 20 by, in this case, resistor 22 acting within the operation unit 90A, means the signal input into motor controller 23 causes the motor 40 to “idle” creating the output equivalent to a slow speed e.g. 1 mph thus causing a “Creep” effect. This modification by the resistor 22 means this is the minimum allowed speed when the motor 40 is on and the mechanical drive system is engaged. The operator then cannot ignore that the vehicle is still in motion. However, the operator can stop the low speed Creep by applying the brakes. The operator can indeed apply the brakes regardless of the speed of the vehicle. By applying the brakes, in this case by activating the brake levers 32 and/or 34, this will active brake switches 18 and 19 which in turn will break the circuit 10. This will cause the motor controller 23 to disengage from applying any power signal to the motor 40 and at the same time will action application of the mechanical brakes 33 and/or 35.

If the operator has brought the vehicle to the slow “Creep” speed generated by the warning circuit, the operator may chose to engage toggle unit 26 in the Safe mode to disengage the application of a power signal to the motor controller 23 and therefore prevent application of power to drive motor 40. By disengaging the power signal to the motor 40 in this way, it remains possible in an example for the motorcycle to be manoeuvred by pushing the handlebars, for example to park the motorcycle, as the brakes 33 and/or 35 are not applied. The main vehicle activation can be on or off at this point, so lighting for example can be present while manoeuvring the vehicle without a power signal being provided to the motor 40.

To resume motion the operator would, if required, activate ignition 14 then engage Live mode via the toggle unit 26. The operation unit 90A would commence the Creep movement and the indicator 70 would be activated. The operator could then use the throttle 50 as required.

The latching controls 28 and latching circuit 27 are desirable as the latching control buttons 36 and 37 can be arranged on the handlebars of the vehicle (not shown) such that for the vehicle to operate, the user must have both hands on the handlebars making it inherently safer to use.

FIG. 1B shows a second embodiment of circuit 10 wherein the circuit 10 is retrofitted to an existing vehicle. In this case, the retrofitted circuit 10 does not require components 17A and 38A as the circuit 10 can be integrated to include ignition indicator 17B and “Kill” button 38B typically provided in an existing vehicle system and which perform the same respective functions. In retro fit conditions where the Safe/stop/kill switch is not momentary, that is a latching switch, it must be returned to a standby position before the start-up procedure is available. Depending on the existing vehicle system to which the circuit 10 is being retrofitted, other components such as the ignition, secondary power source, additional indicators, throttle, brakes, motor controller, digital display devices and other safety interlocks to prevent unintentional Live mode occurring (none of these components are illustrated) can be used within the circuit 10 as required.

FIG. 1C shows a third embodiment of the circuit 10, similar to that of FIG. 1A but wherein the toggle unit 26 comprises a three way toggle switch 26A, indicator light 60 and indicator light 70. Toggle switch 26 is connected to an indicator light 60. The toggle switch 26 can toggle between two settings: one which places the circuit 10 in a Neutral or Safe mode and another which places the circuit 10 in a Drive or Live mode. By setting the toggle switch 26 to Safe the indicator light 60 is illuminated. The indicator light 60 is not illuminated when the toggle switch 26 is positioned to Live, which instead facilitates the signal being sent to activate Live indicator device 70 and subsequently to motor controller 23. However, failure of the indicator light bulb will not affect the function of circuit 10. Use of a multi element light bulb or LED cluster can provide greater certainly of the indicator light 60 illuminating when the toggle switch 26 is placed in neutral mode.

As with the embodiment detailed in FIG. 1A, management of the output of speed from motor 40 can also be initiated by toggle unit 26. Whilst the toggle switch 26A is in Safe mode, the motor 40 is disengaged in a safe, non-operative mode, effectively isolated from the power supply, and the throttle circuit 20 is disabled. When the toggle switch 26A is positioned for Live mode, activation of the throttle circuit 20 and generation of a corresponding power signal by the motor controller 23 will result in the motor 40 responding by causing an increase in speed.

When the ignition 14 is turned on, the circuit 10 is arranged to default into Safe mode. The ignition 14 can be turned off whilst the circuit 10 is in Live mode or Safe mode.

The toggle switch 26A of toggle unit 26, is in this case is a handlebar mounted centrally sprung toggle switch (not shown) can then be moved to activate the circuit 10, and thus the motorcycle, to Live mode. The central spring arrangement of the toggle switch 26A facilitates a momentarily closed circuit in each position which activates a closed circuit enabling selection of the desired control mode. Therefore, when the ignition 14 is switched on, the circuit 10 is activated so that the motorcycle is ready for use, but no power can be applied by the throttle circuit 20 through actuation of throttle handle 50 and no “Creep” will occur as the circuit 10 is in Safe mode. When toggle switch 26A is moved to place the circuit 10 in Live mode, then “Creep” is immediately commenced. The user can stop the “Creep” at any time by the application of rear brake lever 32 or front brake lever 34 or by turning off the ignition 14 or by pushing toggle switch 26A to activate Safe mode. For example, upon the toggle switch 26A being toggled into the Live mode, the circuit 10 may be momentarily opened by the application of the front brake 32 or the rear brake 34 and then Live mode resumed upon release of the brake 32, 34 with the switch 26A returning to the toggled position. Alternatively, the circuit 10 could be opened and the vehicle operation stopped completely by turning off ignition 14. To use the vehicle again, the user will recommence the process by actuating the ignition 14 and moving the toggle switch 26A from Safe mode to Live mode.

The functionality of circuit 10 as described is achievable by various methods of processing the signals from the operator controls, and the desired motor control is then realized through a variety of signal routes to the controller, The throttle, power inputs or other control lines built into standard controllers can be utilised to implement the most convenient embodiments dependant upon the system specifications. Examples shown in FIG. 1A to FIG. 1D. Furthermore the system can be approached as a whole whereby a single multi function control unit is implemented to combine all of the functionality of circuit 10.

FIG. 1D shows a fourth embodiment of the circuit 10 where all control aspects are integrated to one bespoke controller unit 25. The functionality may be achieved in this case by hardware and or software implementation.

In FIGS. 2A and 2B there are shown schematic diagrams detailing the electronics and associated circuit of adjuster unit 95 of operation unit 90A of FIGS. 1A to 1D. A standard timer chip U1, such as LM555, can be used to create a short pulse from a reset signal. The duration of the pulse is set by the timing elements C2 and R3 in dependence upon the nature of the motor controller 23 such that the time delay may be between 1 μs and 5 s for example. The reset line is held high, to automatically reset the circuit, and the control line is decoupled to ground via capacitor C1. The output of timer device 91 is input to switching element 92 which contains an optically-isolated MOS relay. R4 is set high enough such that U2 is not active unless receiving a signal from timer device 91. The output of U2 provides a function such that the input from the throttle is routed either directly to the output, or via resistor 22 and from there to the motor controller 23.

In FIG. 2C there is shown a schematic diagram detailing the electronics logic and associated circuit of circuit 10. Circuit 2C represents the following functionality:

The circuit is based around an SR-latch (U1). This is latched using the output from an AND gate (A8). This ensures both LIVE and INTENT are TRUE. In an implementation, LOW is used as logic 1, or TRUE and then the condition is inverted. These two inputs are buffered (by A5 and A7) in this implementation, but could also be unbuffered. The latch is SET by this condition. This makes output Q TRUE, thus line LIVE_LGT is high. This lights a green light 70. The voltage controlled switch (S2) takes the vehicles supply voltage (which in this implementation is 60V but it could be any voltage) and switches line BRAKE on. S2 is normally open (NO) and if the brake is not applied (brake and other interrupt switches are CLOSED) then current will flow to line A1. This in turn switches on the motor-controller, either directly, or via a relay, a contactor, or something similar. In an implementation it is direct. If, whilst Q (ACTIVE/LIVE) is TRUE and INTENT is also TRUE—brake interlock override mode—the output of A6 is TRUE. This switches the voltage controlled switch, S1. This in effect bypasses any brake switches that are OPEN (brakes applied) and allows the continued use of the motor whilst the brakes are still applied. In an implementation, A1 to A8 are a combination of NOR gates on an LS7402 IC for example, and S1 and S2 can be P-channel CMOS transistors. Decoupling capacitors and pull-up resistors are implemented as necessary.

In FIG. 3 there is illustrated a second embodiment of an operation unit 90B which could replace 90A within the circuit 10 of FIG. 1. As can be seen, operation unit 90B comprises an adjuster element, in this case variable resistor 22, and motor controller 24. The motor controller 24 is provided with a modified HPLO circuit (not shown). The modified HPLO (MHPLO) circuit accommodates the fact that a signal being inputted to the controller 24 from the resistor 22 will never reach zero due to the modifying effect of resistor 22 on the signal generated by the throttle circuit 20. The MHPLO controller 24 would be set to recognise a new base level signal, which is a signal indicating zero speed, in accordance with the modified slow throttle signal being produced. Thereafter, the throttle circuit 20 must be reset each time the motor controller 24 is turned off, in the usual manner of a typical HPLO circuit, by disabling the controller 24 until the throttle circuit 20 is adjusted.

When the toggle switch 26A is in Live mode, and the controller 24 is providing a drive signal to motor 40, activation of either one or both brake switches 18 and/or 19 will break the circuit 10. This will cause the motor controller 24 to disengage from applying any power signal to the motor 40 and at the same time will action application of the mechanical brakes 33 and/or 35. In turn, the throttle circuit 20 will, in view of the MHPLO circuit, have to be reset by the operator so that on release of the brakes 32 and/or 34 the motor controller 24 can re-connect and power be supplied to the motor 40 thus preventing any unexpected acceleration on release of the brakes.

In FIG. 4 there is shown a third embodiment of an operation unit 90C which could replace 90A within the circuit 10 of FIGS. 1A to 1D. Operation unit 90C comprises a motor controller 25 into which is integrated the functionality of adjuster unit 95 including adjuster element 22, such as a variable resistor. In this embodiment, the Creep effect of the circuit 10 is integral to the simplified hardware of motor controller 25. The motor controller 25 may be provided with an HPLO circuit, however the safety system functionality of the motor controller 25 will not be altered adversely if no HPLO circuit is included.

In FIG. 5 there is shown a fourth embodiment of an operation unit 90D which could replace 90A within the circuit 10 FIGS. 1A to 1D. In this embodiment, operation unit 90D comprises a basic motor controller 21, which is not provided with an HPLO circuit, and the adjuster device 22 which is, in this case, a variable resistor which acts upon the signal generated by the throttle circuit 20 such as to prevent an output signal equivalent to zero speed being input to the motor controller 21. Instead, the modified signal input into the motor controller 21 is equivalent to a slow speed or minor movement.

In FIG. 6 there is shown another embodiment wherein the circuit 10 comprises a power supply 12 which is derived from the power supply to the vehicle, typically a battery (not shown), ignition 14, system status device 16, a toggle unit, which in this case is a three way toggle switch 26A; an indicator unit 70; operation unit 90E comprising a controller unit, in this case motor controller 21 and resistor 22; a switching unit 30, in this case comprising brake switches 18 and 19, which are closed in the default position; and a throttle unit, in this case throttle circuit 20, all of which are connected in series. In this embodiment, the throttle circuit 20 is interrupted by the brake switch circuit 30, and the controller power signal is maintained stable during the operation process. This would be applicable to controllers that are microprocessor controlled and therefore not suitable to regular switching of main power input. This arrangement may be used for reasons of simplicity of the hardware or software or for reasons of convenience generally. This is in contrast to some previous embodiment wherein the brake switch circuit 30 acts on the ignition line of the controller. Operation unit 90E is as detailed in FIG. 6, however it will be appreciated that any suitable operation unit may be used within this circuit 10.

In another embodiment of the circuit 10, the throttle circuit 20 includes a potentiometer (not shown). In a voltage dividing throttle system, the throttle handle 50 is linked to a voltage divider in the throttle circuit 20. As the throttle handle 50 is actuated a voltage variable between, for example, 0-5V is supplied to the operation unit 90A to 90E, where it is modified by the adjuster unit 95 or adjuster element 22 and sent to the controller 21, 23, 24 or 25 providing a signal indicating the desired speed to be output from the motor 40. In this embodiment, an MHPLO or HPLO circuit in the controller 23, 24 or 25 operates dependent upon the voltage at the speed signal input when the controller 23, 24, 25 is switched on.

In another embodiment of the circuit (not shown) the switching unit comprising the brake switches 18 and 19 could further be provided with a spring loaded non-latching over-ride button which by-passes the switches 18 and 19. The over-ride button would be used as a momentary switch to allow easier hill starting by enabling the motor controller 24 to be provided with a drive signal via toggle switch 26A when the ignition is on and the toggle switch set to drive mode, thus allowing the brake 33 and 35 to be applied whilst preparing to operate the vehicle.

Each of the above embodiments is suitable for use with vehicles that have regenerative braking as well as vehicles which do not have regenerative breaking.

Vehicles without regenerative braking can operate in Safe and Live modes. However, vehicles with regenerative braking can operate in Safe, Live modes and in an additional Regen mode. In vehicles with regenerative breaking, Live and Regen modes may apply simultaneously. That is, Regen mode can be activated and deactivated while in Live mode. A minimum signal level adjustment, applied to the signal output from the throttle circuit 20 as detailed above can, in a regenerative braking system (not shown), be applied to the regenerative braking control signal. The minimum signal level adjustment would in this case be applied to the Regen control signal by an adjuster unit such as adjuster unit 95 or adjuster element 22. The adjuster unit 95 would have the effect of allowing a Regen control signal to range from hard braking down to very slight braking but not to allow zero Regen braking while in Regen mode for example. Once a vehicle has completed a Regen deceleration, the slowest speed reached is approximately Creep speed. The Regen control signal may be generated by a variety of unspecified methods; the adjustment of this to achieve the minimum effect described may be integrated to the method or applied as an additional element.

In each of the above embodiments, the normal start up procedure preferably involves the operator sitting on or in or standing over the vehicle before engaging Live mode and subsequently Creep by using the ignition key to turn on the power to auxiliary devices first and then, either in the same action or in a subsequent position in a multi stage key switch, enable the toggle unit 26. This illuminates the power light 17A or 17B which indicates the circuit 10 is now active, and with no further action will remain in Safe mode. Indicators 17 A and 17B would preferably be blue in colour and preferably red Indicator 60 is also illuminated at this point, other colours could be used, To move from Safe mode to Live mode, the operator actuates the toggle unit 26 by firstly holding the Intent button 36 and simultaneously pressing the Live button 37 and Creep is commenced. While in Live mode the indicator 70 illuminates and remains illuminated even when Creep is temporarily disabled when any of the brakes 32-35 are applied and Creep will resume as soon as the brakes 32-35 are released. If the any of the brakes 32-35 are applied whilst the throttle 50 is also applied, the motor movement is again disabled until the brakes 32-35 are released with Creep resuming even if the throttle 50 is still applied. In embodiments of the circuit 10 provided with an HPLO circuit, the throttle 50 must be returned to zero as a reset before operating normally and if the Intent button 36 is used as a brake override button, HPLO functionality will remain during this override.

The circuit 10 will remain in Live mode unless the Safe switch is activated either momentarily or by pressing it permanently to Safe, the ignition is turned off or a secondary power switch or other safety system including those incorporated through retrofitting is actuated. Once Live mode is deactivated, it can only be resumed or reactivated by the operator following the start-up procedure. Whilst braking is only a temporary interruption to Live mode, in embodiments detailing latching circuit 27, Live mode can only be resumed by using Intent button 36 and Live button 37. Furthermore Live mode will only be activated if Intent button 36 is pressed first and held in before pressing the Live button 37.

The movement created by the circuit when in Safe mode has been called “Creep” and may be a slow forward motion. However it will be understood that any small regular or irregular, forward or backward movement such as “judder” could be understood as being Creep for the purposes of this vehicle warning system.

The warning system may be used in vehicles with or without gearing whether mechanical, electrical or another type. The effect of the minor movement or slow speed Creep will be present whenever the operator has the ignition 14 on and the toggle unit 26 is set to Live mode unless the brake switch 18 and/or 19 is activated. If gearing (not shown) is present and engaged in the vehicle, the slow speed Creep will still be present. If the gears are disengaged, the Creep will cease temporarily but commence as soon as the gears are re-engaged. If there is a mechanical neutral or a mechanical clutch in the vehicle system then the warning effect of Creep would be ineffective between gears or while the clutch is engaged.

In addition, the circuit 10 of the above embodiments is suitable for retrofitting into existing vehicle systems. In the case of the circuit 10 being retrofitted, it will be possible for the motor to be in Safe mode, effectively isolated from the power source whilst the main ignition circuit (not shown) can remain enabled to provide power for other systems on the vehicle such as lights or satellite navigation for example.

A further embodiment of the start-up procedure could replace the pressing of the Live button with an activation of the throttle to engage Live mode.

Various modifications may be made to the embodiments hereinbefore described without departing from the scope of the invention. For example, the system has been described with reference to electrically powered motorcycles, however it will be understood that electric bikes, electric trikes, electric quad bikes, mopeds, motorcycles or other electrically powered vehicles such as cleaning machines, golf carts and disabled vehicles, hybrids and partially electric vehicles could also be provided with the system. Typically these electrically powered vehicles are of the type operable by handlebars and joysticks.

The circuit 10 is detailed as being powered from the same source as the vehicle however it will be understood that the circuit 10 could be powered by a power source separate from the source of the power to the vehicle without impinging on the performance or function of the circuit 10.

The term circuit is used widely within the following descriptions, it is understood that this term does not represent specific hardware but more a logical system which may be achieved through microprocessors, coding or software systems, or other logic means unspecified.

Whilst the system has been detailed as having a twistable throttle handle 50 it will be appreciated that any suitable throttle, for example handlebar mounted throttles in the form of sprung levers or buttons, or rotational levers or buttons typically fitted with a spring return may similarly be used. Furthermore the throttle may be mounted on handlebars but may alternatively be located elsewhere on the vehicle. The term throttle is used widely in the descriptions, it is understood that this term could be replaced by accelerator or other term with similar meaning.

Furthermore, the system has been detailed as having variable resistor or voltage divider controlled throttles, both of which are easily supported by the system upon an appropriate controller being used. However, there are other throttle types which could similarly be used.

The throttle signal may be subject to additional adjustments unspecified resulting from control means unspecified.

Although relevant aspects of throttle circuit 20, toggle unit 26, latching circuit 27, latching circuit controls 28, switching unit 30, operation units 90A to 90E and adjuster unit 95 have been detailed as being a stand alone component or arrangement of components, it will be understood that functionality of these devices may alternatively be provided by the motor controller 21 23 24 and 25 either within their components or within programming of the circuitry. The functionality of these components may also be combined into one or more general or specific control units.

Whilst the toggle switch 26A and buttons 36, 37, 38A and 38B of the latching circuit controls 28 have been detailed as being a handlebar mounted switches, it will be appreciated that they may alternatively be any suitable switching type mechanisms including, but not limited to a foot pedal lever. Such a foot pedal lever may be mounted at either side of the vehicle in place of a standard gear change lever. The foot lever may be arranged such that an upward position of the lever equates to Safe mode and a downward action to a downward position equates to Live mode for example.

The system according to examples has been described as having no multi voltage/amperage control interlocks or other interlock devices, integrating high power and control circuitry, such as but not limited to solenoids, contactors or high power relays; such devices are common in circuits of the types described and the addition of these into further embodiments could be achieved while maintaining the functionality described.

The brakes 33 and 35 have been described as being mechanical brakes, however it will be understood that these could alternatively be hydraulic brakes or any other suitable braking systems available.

The potentiometer in throttle circuit 20 has been described as providing a resistive range of 0-5 kΩ however it will be understood that the equivalent performance could be achieved from any range of resistance or any range of voltage

Whilst indicators 17A and 17B, 60, 65 and 70 have been detailed above as being a light which illuminates as a warning, it will be appreciated that any suitable warning device which can be activated when necessary could similarly be used including but not limited to an audible alert. In addition, it will be appreciated that these indicators may be arranged in any suitable location upon the vehicle.

Furthermore, whilst the adjuster unit has been detailed as being resistor 22, it will be appreciated that an alternative component or group of components which would create minor movement by provision of a modified signal or “judder” signal to the motor which provides feedback to the operator that the circuit is in a Live mode could alternatively be used.

Ignition 14 has been described as a key switch operating the circuit 10 but it will be appreciated that the ignition 14 may also operate other peripheral circuitry switching functions such as, for example, lights. However, other peripheral circuit switching functions may alternatively be actuated by other switches separate from the ignition 14. Furthermore, ignition 14 may be any suitable switch type such as a key switch but also, for example, a rocker switch or a push button switch.

1. A circuit, for controlling a vehicle having an electric motor, the circuit comprising:
throttle means operable to generate an output signal;
adjuster means operable to modify the output signal to above a predetermined minimum level, and
controller means operable to receive the modified output signal and derive an input signal for provision to the electric motor.

2. A circuit as claimed in claim 1 wherein the output signal generated by the throttle means is an indicator of required output of the electric motor.

3. A circuit as claimed in claim 1 wherein the throttle means is operable to generate an output equating to zero output from the electric motor.

4. A circuit as claimed in claim 1, wherein the adjuster means is operable to modify the output signal equating to zero output from the electric motor such that a minimum output above zero is obtained from the motor.

5. A circuit as claimed in claim 1, wherein the circuit further comprises a switching means operable to selectively disengage the controller means from the electric motor.

6. A circuit as claimed in claim 1, wherein the switching means comprises at least one brake switch.

7. A circuit as claimed in claim 1, wherein the switching means comprises a toggle means wherein the toggle means is operable to latch the circuit between at least two states.

8. A circuit as claimed in claim 7 wherein the toggle means comprises a latching circuit.

9. A circuit as claimed in claim 8 wherein the toggle means further comprises a latching control unit.

10. A circuit as claimed in claim 6 wherein the toggle means comprises a toggle switch.

11. A circuit as claimed in claim 1, wherein the throttle means includes a variable resistor to supply a variable resistance signal to the controller means to change an output from the electric motor.

12. A circuit as claimed in claim 1, wherein the throttle means includes a potential divider.

13. A circuit as claimed in claim 1, wherein the throttle means includes a potentiometer.

14. A circuit as claimed in claim 1, claim wherein the adjuster means is a resistor.

15. A method for controlling an output of an electric motor in a vehicle, comprising: modifying an output signal of a throttle control of the vehicle to generate an input signal for the electric motor representing a minimum output for the motor when the output signal corresponds to zero output from the motor.

16. A method as claimed in claim 15, wherein a minimum output for the motor maintains a predetermined minimum speed of the vehicle at zero throttle.

17. A circuit, for controlling a vehicle having an electric motor, the circuit comprising:
throttle means operable to generate an output signal;
adjuster means operable to modify the output signal to above a predetermined minimum level;
controller means operable to receive the modified output signal and derive an input signal for provision to the electric motor, and
toggle means operable to latch the circuit between at least two states wherein each state corresponds to a mode of operation of the electric motor.

18. A circuit as claimed in claim 17 wherein the toggle means is a toggle switch.

19. A circuit as claimed in claim 17 wherein the toggle means is a latching circuit.

20. A circuit as claimed in claim 17 wherein the toggle means further comprises a latching control unit.
